(19) United States
(12) Patent Application Publication
(10) Pub. No.: US 2007/0162933 A1
(43) Pub. Date: Jul. 12, 2007

(54) DYNAMICALY MIXING AND STREAMING MEDIA FILES

(75) Inventors: Jeffrey Hays, Sandy, UT (US); Darren L. Wesemann, North Salt Lake, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Podfitness, Inc., Sandy, UT (US)

(21) Appl. No.: 11/690,740

(22) Filed: Mar. 23, 2007

Related U.S. Application Data
(63) Continuation-in-part of application No. 11/383,921, filed on May 17, 2006.
(60) Provisional application No. 60/682,361, filed on May 18, 2005.

(51) Int. Cl. H04N 5/445; H04N 7/10; H04N 7/025; G06F 13/00; G06F 3/00

(52) U.S. Cl. 725/46; 725/34; 725/35

(57) ABSTRACT

Embodiments relate to a web-based interactive fitness program for generating individualized fitness media content for subscribers. A database is maintained that includes scriptlets that identify exercise routines that have been provided or augmented by a trainer. One or more of the scriptlets are selected for a subscriber based on the subscriber's information. The selected scriptlets are then compiled into media content that is streamed to the subscriber for use. Various devices associated with the subscriber may provide real time input to the database while the subscriber is experiencing the media content. In response to the real time input, new scriptlets may be selected and modified media content may be streamed to the subscriber for use.

### CROSS-REFERENCE TO RELATED APPLICATIONS

This application is a continuation-in-part of U.S. patent application Ser. No. 11/383,921, filed May 17, 2006, which claims the benefit of U.S. Provisional Patent Application Ser. No. 60/682,361 filed May 18, 2005. The foregoing patent applications are incorporated herein by reference in their entirety.

### BACKGROUND OF THE INVENTION

1. The Field of the Invention

The present invention relates to the field of media content. More particularly, embodiments of the invention relate to systems and methods for generating customized media content that includes a workout routine.

2. The Relevant Technology

People today have interests that can vary widely from one person to the next. Some people are interested in learning, others are interested in travel, and still others enjoy exercising. These types of activities can bring satisfaction to our lives. As a result, people often strive to improve in areas or activities they are familiar with as well as try new activities. One of the best ways to achieve good results in a given activity is to seek advice or suggestions from someone that is an expert in the relevant subject.

For example, cooking schools have expertise in teaching people to cook, colleges provide professors for a wide variety of subjects, travel agents are familiar with trip destinations, and trainers are able to improve the way one exercises. In each of these cases, the subject matter expert is able to help people achieve their goals. It makes sense that a chef can teach one to cook or that a trainer can provide instruction to help one achieve his or her fitness goals.

The experience and expertise of a subject matter expert can help us in a variety of ways. Subject matter experts, for example, often have the ability to identify a preferred course of conduct or a preferred course of study. For instance, a travel agent can suggest activities to do and sites to see at or near a particular destination. A college professor can explain difficult concepts and help improve one's understanding of a particular topic. A personal trainer can formulate a workout routine tailored to one's goals, interests, and abilities.

Unfortunately, seeking and obtaining the service of a subject matter expert can often prove difficult and expensive. For instance, one wanting to achieve a fitness goal would probably seek a personal trainer. There are several reasons, however, that may prevent one from seeking the assistance of a personal trainer. For example, the cost of personal trainers, the current demand for personal trainers, scheduling conflicts, travel issues, and the like are examples of reasons why a particular subscriber may not be able to find and benefit from the experience and expertise of a personal trainer. As a result, many individuals are left without the support and instruction needed to achieve desired fitness goals. These challenges and others may similarly prevent individuals from receiving the support and instruction they need in other subject areas, such as travel, cooking and education, to name a few.

One attempt to fill this void can be found, for example, in DVDs, videocassettes, and the like. Even though the DVD may have content prepared by a subject matter expert, it is difficult if not impossible to alter the content of the DVD. In other words, the DVD is typically mass produced and is not individualized for a particular user. As a result, the DVD is unable to dynamically adapt to the changing circumstances of the user.

Thus, the ability to bring the expertise of a subject matter expert in a dynamic way is lacking in existing technology. There is therefore a need to create instructions and personalized content in a portable medium to allow a subscriber to take personalized media content with them in any location and for any subject.

### BRIEF SUMMARY OF THE INVENTION

The following describes embodiments of methods and systems related to the needs discuss above. Note that these embodiments are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the invention relate to methods of creating individualized media content, an example of which is workout routines presented via media content. Advantageously, the media content can be prepared for each specific subscriber. For example, when the media content includes workout routines, the media content can be prepared using the experience and knowledge of a personal trainer. Furthermore, the media content can be modified in response to real time input. Other examples may include but are not limited to instructional tutorials, entertainment media and news or information dissemination.

In one embodiment in which the media content includes workout routines, a server is used to collect information from personal trainers and other persons in a database. This information includes exercise philosophies that are defined in terms of methods, rules, and attributes. A customized workout routine can be generated by identifying various parts of the database that match or are appropriate for a subscriber's condition or status. The identified parts (or scriptlets) can be mixed and streamed to a user a portion at a time. The user can then experience the media content during a workout routine and enjoy the experience and knowledge of at least one personal trainer. Various devices associated with the user can provide real time input to the server, which can be used to modify the streaming media content.

For example, one embodiment of the method includes processing individualized subscriber attribute information in a knowledge base module, which stores or has access to the information provided by at least the trainers. The knowledge base module compares subscriber attribute information with the stored scriptlet identification information to identify matching scriptlet identification information that matches the individualized subscriber attributes information. Next, a clip list is created from the matching scriptlets. The method further includes streaming media clips associated with the clip list to the subscriber.

A system for creating individualized media content is disclosed. The system includes a database. The database includes a plurality of scriptlets. The system further includes a knowledge base module configured to receive individualized subscriber attribute information stored in the database. The knowledge base includes a data-query function configured to compare the individualized subscriber attribute information to the plurality of scriptlets to identify scriptlets associated with the subscriber attribute information. The knowledge base further includes a rules function configured to create a list of media clips associated with the scriptlets associated with the subscriber attribute information.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1A illustrates an example operating environment in which embodiments of the invention can be implemented;

FIG. 1B is an illustration of an example of the various computer program modules and data processing engines that create individualized media;

FIG. 1C depicts various inputs that the subscriber module of FIG. 1B may be configured to receive;

FIG. 2 is a flow diagram illustrating a process for creating individualized media;

FIG. 3 illustrates various data structures created and stored by a trainer module;

FIG. 4 is a block diagram illustrating various data structures that contain information about a trainer's philosophies;

FIG. 5 illustrates various exercises data structures;

FIG. 6 illustrates various data structures that can be associated with the exercise data structures of FIG. 5;

FIG. 7 illustrates various data structures for associating media clips with the data structures of FIGS. 4, 5, and 6;

FIG. 8 illustrates various data structures describing subscribers;

FIGS. 9 and 10 illustrate various data structures that can be generated by a knowledge based module of FIG. 2;

FIG. 11 illustrates a broad overview of a workout file;

FIG. 12 illustrates a more detailed view of the contents of an exercise portion of a workout file;

FIG. 13 illustrates a detailed view of cadence example in a workout file; and

FIG. 14 illustrates a control flow schematic of the interaction between a subscriber and a system for performing the methods discussed herein.

### DETAILED DESCRIPTION OF THE INVENTION

The embodiments of the invention described herein relate to methods, systems, and/or computer program products for providing individualized media content to a subscriber. The media content can relate to various subject matter and/or activities that a subscriber may desire to perform, study, experience, and the like. Embodiments of the invention generate media content that combines pre-defined content with content that represents the expertise and experience of subject matter experts. The pre-defined content and the content from subject matter experts is stored in a database (referred to herein as a knowledge base).

The development of the knowledge base can develop over time as additional subject matter experts add content. A subscriber can then provide his or her own information, which is used to access the knowledge base and identify specific data, for example, media clips, that suit the subscriber. The identified data can then be mixed and provided to the subscriber. In this manner, the media content delivered to the subscriber includes content from subject matter experts and that is tailored to the subscriber.

Embodiments of the invention are directed towards media content that is directed to health issues, such as information relating to diet and general health information, exercise, proper use of exercise equipment, proper techniques for different exercises, etc. The media content can include personalized instructions for a workout routine that enable users to have the benefit of personal trainers. One of skill in the art can appreciate, with the benefit of the present disclosure, that the media content, the knowledge base, and the like can be developed for other activities or sessions as well and can include content directed to subjects other than exercise.

Embodiments of the invention relate to generating individualized exercise programs for an individual user that can be delivered to the user as media content. When generating the media content, information can be received and/or collected from various experts, administrators, and/or individual subscribers (or “users”) to manage information and rules for correlating the information to generate individualized exercise programs for the individual user. This information may be collected or received over a network, such as the Internet, and stored in a server. The stored information can then be coordinated to generate specific instructions for a user that can be delivered to the user as media content such as a media clip or media stream.

For example, the exercise programs can be generated by a computer-managed server that interacts with various entities via a network, such as the Internet. The server can present a graphical user interface, such as a website or webpage, such that the server can receive, from various entities, information to be input that is used for generating the individualized exercise media content. The different entities that provide attributes and rules can include subject matter experts, subscribers, and administrators. The subject matter experts can be divided into various groups that provide different data as described below. Knowledge engineers are examples of subject matter experts. When the media content is related to exercise, trainers are also examples of subject matter experts. The bulk of the information, however, can be provided by the knowledge engineers, trainers, and subscribers rather than the administrators who may be responsible for the general maintenance of the user accounts, systems and database infrastructure at the server.

A knowledge engineer can also be referred to as an internal Subject Matter Expert (“SME”) responsible for internal pre-defined content stored at the server. This predefined content can include the various tables including attributes and exercises, for example, for selection by subscribers and trainers. The knowledge base includes content that is defined and maintained by the internal subject matter expert. In one embodiment, the pre-defined content includes building blocks that can be customized by external SMEs. Examples of external SMEs include professors, chefs, travel agents, personal trainers and other knowledgeable professionals whose knowledge may be of interest to subscribers.

The knowledge base of predefined content also includes media clips or scriptlets that have various attributes. An internal SME can access these media clips and perform various maintenance functions (add, delete, amend, etc.). For example, exercise media clips may have attributes that define which body part is being used, what equipment should be used, how the exercise should progress, and the like.

The trainer (an external SME) can be responsible for defining training philosophies in terms of methods, rules, and attributes. These philosophies can be combined with the pre-defined content submitted by the knowledge engineer and included in the knowledge base. In turn, the knowledge base can be used to generate and provide the individualized workouts to the subscribers.

The subscriber is the entity for which the individualized media content is generated. The subscriber provides subscriber attributes, which may include information such as updates regarding subscriber fitness progress, and subscriber goals. Real time information may also be provided by or for the subscriber. This information provided by the subscriber is compared with the information received by the server from the knowledge engineer and trainers to match the subscribers attributes, progress, and goals with various scripts or scriptlets to create a matching, adaptive, individualized exercise program.

The information received from the subject matter experts (e.g., knowledge engineer, trainer) and from the subscriber can be stored as data structures, such as tables and table entries, in computer readable media along with identifiers and associations with other data structures in order to create rules for generating individualized training programs.

The individualized training programs can be generated according to a template, which may be predetermined, and the template used can create associations between data structures to be used as inputs to rules for selecting media clips and/or customizing media clips or other media content. For example, an individualized training program template can include any combination of a (1) pre-workout introduction, (2) warm-up, (3) exercise, including an exercise introduction, description, instructions, tips, etc., (4) set, including a count through repetition of a set, (5) warm-down, and (6) post-workout conclusion. Each of the various aspects of the program template can be part of the pre-defined content of the knowledge base.

Each portion of the individualized training program can be generated based on different rules taking into account certain information (such as the subscriber attributes) received from the subscriber. These, as well as many other, aspects of the various embodiments discussed in detail below are also illustrated in the Figures referred to herein.

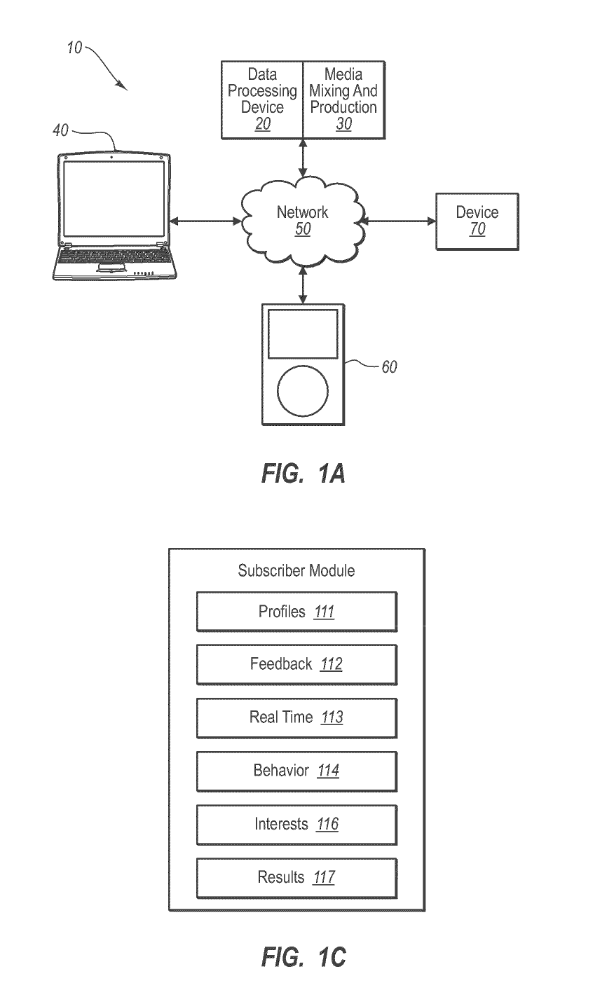

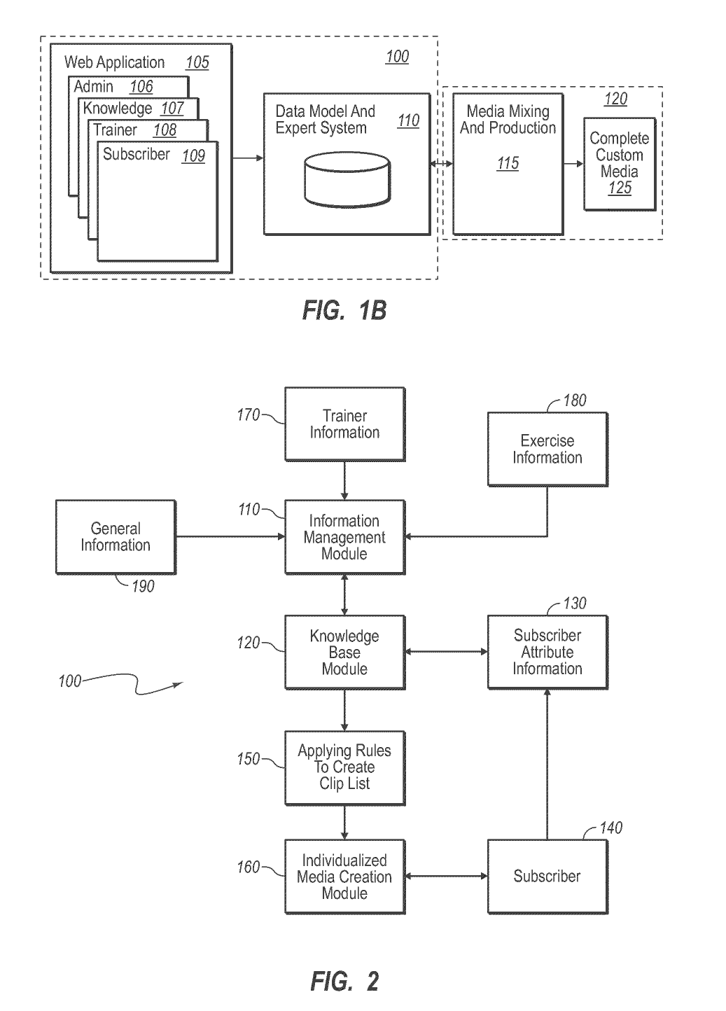

FIG. 1A illustrates an example operating environment 10 in which embodiments of the invention can be implemented. The operating environment 10 includes a network 50 through which a data processing device 20 (e.g., a data center or server), a media mixing and production (“MMAP”) module 30, a client computer system 40, and a content player 60 can communicate. Optionally, there may be one or more subscriber devices 70, or devices associated with the subscriber. The network 50 may include a public switched telephone network, an internet protocol network, a wireless RF network, and the like or any combination thereof.

In operation, a subscriber can use the client computer system 40 to subscribe for the services provided according to embodiments of the invention. For instance, a web browser on the system 40 can be used to access the data center 20 and input information for a profile associated with the subscriber. Other subscriber information can also be provided to the data processing device 20 and can originate from various sources. The data processing device 20 uses the subscriber information to identify specific media clips (or other information accessible to the data processing device) that suit the subscriber.

The specific media clips are provided to the MMAP module 30 to generate individualized media content which the subscriber can experience using the system 40 and/or the content player 60. The MMAP module 30 can be integrated as part of the data processing device 20 or can be a separate module. In one embodiment of the invention, the MMAP module generates a complete media content file before providing it to the subscriber. In another embodiment, however, the MMAP module streams media content to the subscriber. The media content can include audio content, video content, and combinations thereof, and the subscriber experiences the content by using the content player 60 to listen and/or view the content.

The device 70 is a device associated with the subscriber that can provide real time subscriber information to the data processing device 20. As an example, the device 70 may comprise a heart rate monitor, a treadmill, or any other device having network capabilities that the subscriber uses or that is otherwise associated with the subscriber while the subscriber is experiencing the media content. The device 70 may simply provide a user interface such that the user may (by speaking or keying a response) provide feedback during the time in which the user is experiencing the streamed media. In some embodiments of the invention, the device 70 and/or the content player 60 include Wi-Fi, Bluetooth, GPRS and/or other wireless capabilities to access the network 50.

According to embodiments of the invention, the subscriber creates a profile on the data processing device and media content is generated and streamed to the subscriber (e.g., via the content player 60). While experiencing the streaming media content, the data processing device receives real time input associated with the subscriber from the content player 60, the device 70, or from some other source. The data processing device 20 can then use the real time input to modify or change the streaming media content. Advantageously, this permits media content experienced by the user to be adjusted in response to real time factors.

FIG. 1B is a high-level illustration of the various computer program modules and data processing engines that create individualized media content. FIG. 1B includes a first data processing device 100 corresponding to the data processing device 20 of FIG. 1A. The data processing device 100 hosts a web application 105 that is used to gather information from an administrator module 106, knowledge engineer (or internal SME) module 107, trainer (or external SME) module 108, and subscriber module 109. The subscriber module 109 is used to collect information about subscribers, which the subscribers may provide via a web browser on the client computer system 40 of FIG. 1A. The knowledge engineer module 107 and trainer module 108 are examples of modules that can be used to collect information on varied subject matter from subject matter experts. In many examples discussed herein, the subject matter relates to exercise.

As previously stated, however, the subject matter collected by subject matter expert modules is not limited to exercise, but extends to other activities or sessions. For example, embodiments of the invention can be used to customize study programs (the subject matter experts may be teachers or professors) where the media content is a customized lecture, trips (the subject matter experts may be travel agents) where the customized media content relates to an itinerary or to historical sites visited during a trip. Embodiments of the invention can be used to generate media content that can guide a user through a museum (or for other guided expeditions) based on the user's interests and information from subject matter experts that relates to the user's interests. Embodiments of the invention generally apply to any situation where the knowledge of a subject matter expert can be customized into media content and delivered to a user.

The content provided by the various subject matter experts is stored as data structures by the first data processing device 100, such as a server hosting the web application. The data structures are accessed by a data modeling and expert engine 110 that compares the data structures according to rules to identify information submitted by the knowledge engineer and trainer that matches or is appropriate for information submitted by the subscriber.

The data model and expert engine 110 can associate the matched information with scriptlets created by the knowledge engineer module 107 and trainer module 108 and create a scriptlist that includes a list of identification information for each identified scriptlet. The scriptlist is then communicated to a media mixing and production module 115 within a second data processing device 120 or to the same processing device 100 in an alternative embodiment. The second data processing device 120 can be a computer terminal that requests the scriptlets from the first data processing device 100.

The first data processing device 100 hosting the web application 105 communicates the scriptlets to the media mixing and production module 115 executed at the second data processing device 120. According to one embodiment of the invention, the media mixing and production module 115 assembles the scriptlets according to the scriptlist to create a completed individualized media file 125 and stores the individualized media file in a computer readable medium or uploads the individualized media 125 to a portable electronic device.

In another embodiment of the invention, the media mixing and production module 115 does not receive and assemble scriptlets into a single file according to a completed scriptlist received from the data model and expert system 110. Instead, the media mixing and production module 115 streams media content to a subscriber's portable electronic device. According to this embodiment of the invention, the media mixing and production module 115 can receive a portion of a scriptlist, along with the corresponding scriptlets, and mix the scriptlets into a media stream. As portions of the scriptlist are received from the data model and expert system 110 in real time, the media mixing and production module 115 continues to mix the scriptlets and stream the corresponding media stream. Advantageously, this permits the scriptlist (and consequently the media) to be modified and/or changed in response to real-time input received at the subscriber module 109.

As previously mentioned, the subscriber module 109 is used to collect information about subscribers, the information being used as input for the data model and expert system 110. The input can originate from a variety of sources and/or devices having network connectivity and associated with each subscriber and can be provided in real time. Examples of subscriber information are illustrated in FIG. 1C and include subscriber profiles 111, subscriber feedback 112, real time activity 113, behavior 114, interests 116 and results 117. In more detail, subscriber profiles 111 include information about a subscriber, such as the subscriber's age, height, weight, goals, etc.

Feedback 112 can be received from a subscriber after the subscriber has received and experienced media content on one or more occasions. Feedback can be provided in real time (e.g., while the subscriber is experiencing the media content) or after the fact, via the subscriber's content player, computer, or other device. In a study program example, a subscriber may experience a streaming lecture using a content player. If the lecture is too detailed or not detailed enough, the user may be able to push a button, a series of buttons, or otherwise provide feedback using the content player to indicate that the lecture is too detailed or not detailed enough. This information is transmitted to the subscriber module, provided to the data model and expert system 110 and used to generate an appropriately modified streaming lecture providing more or less detail, as requested. Alternately, the subscriber can provide feedback via a computer after experiencing the lecture.

Real time activity information 113 is received from devices associated with the subscriber, while the subscriber is experiencing the media content. In a workout example, a subscriber can perform a workout using a heart rate monitor, treadmill, or other workout device having network capabilities, while also experiencing streaming workout media content. Information from these devices can be transmitted to the subscriber module 109, provided to the data model and expert system 110, and used to appropriately modify media content streamed to the subscriber. For instance, if the heart rate monitor transmits information indicating that the subscriber's heart rate is below or above a target heart rate specified for the workout, the intensity of the streaming workout may be modified accordingly to help the user reach the target heart rate.

Behavior information 114 includes patterns over time for a subscriber. These patterns may be identified by the data processing device 100 and used by the data model and expert system 110 in generating scriptlists. Interests 116 include information about interests of a subscriber.

Results information 117 includes information relating to the results of a subscriber's use of media content. This information can be generated in a number of ways. For instance, in a workout example, the data processing device 100 might calculate how many calories a subscriber has burned. The data processing device 100 could use information provided during the workout (such as heart rate) and the amount of time the subscriber was at a particular heart rate, along with the user's weight from the user profile, to make this calculation. This information could be provided to the data model and expert system 110 and used to generate media content informing the user of how many calories were burned.

While specific examples of adaptable streaming media content have been disclosed involving study programs and exercise, embodiments of the invention can be implemented for adaptable streaming media content relating to other subject matter as well. By way of example only, a subscriber may use a content player to receive streaming media content describing exhibits in a museum. The subscriber can push a button on the media player or otherwise provide input indicating that an exhibit is being skipped, or that the subscriber is done viewing a particular exhibit, etc. In response, the media content streamed to the subscriber's media player can be modified appropriately, such as by not including media content associated with the skipped exhibit, terminating the streaming of content associated with the exhibit the subscriber is no longer viewing, and so on.

FIG. 2 is a flow diagram illustrating a process 100 for creating individualized media. The process 100 uses a knowledge base module 120 for processing personalized subscriber attribute information retrieved by subscriber attribute information module 130 along with exercise and trainer information stored in an information management module 110 to create a list of scriptlets for selection. The information management module 110 manages and stores information associated with scriptlets retrieved by a trainer information module 170 from trainers, exercise information module 180 from knowledge experts, and general information module 190 from knowledge experts. More generally, the trainer information module 170 represents an external SME module 170 for retrieving scriptlets from external SMEs while the exercise information module 180 represents an internal SME module for retrieving scriptlets from internal SMEs.

Logic rules may then be applied 150 by comparing personal information from subscriber attribute information module 130 with exercise (or other subject matter) scriptlet information from information management module 110 to create a scriptlist. In some embodiments, the personal information is compared with metadata to identify the specific scriptlets or media clips. The scriptlist includes a list of media clips to be assembled to create individualized media using an individualized media creation module 160. Upon assembly, the individualized media is communicated to the subscriber 140. The subscriber 140 may upload the individualized media clips to a personal media player such as an MPEG audio layer 3 (.mp3) player or other personal media device. Alternately, the media can be streamed to the subscriber's personal media device.

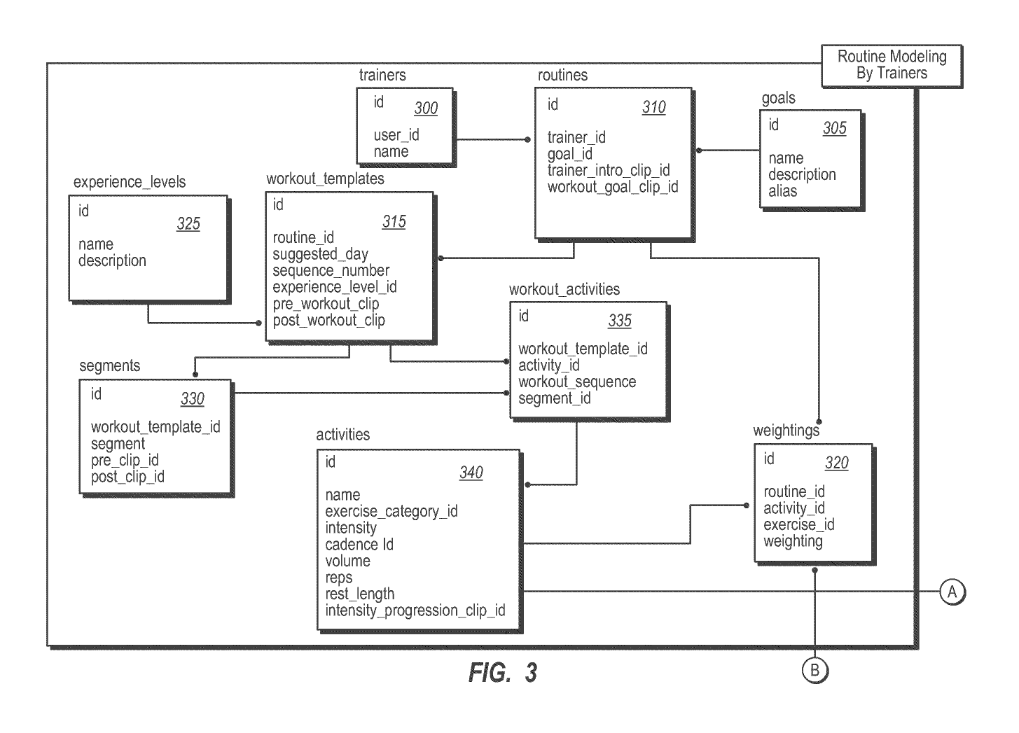

FIG. 3 illustrates example data structures created and stored by a trainer module (or other external subject matter expert module), such as trainer information module 170 in FIG. 2. The trainer module can provide a user interface for the trainers to define their unique workout philosophies. Selection of predefined exercises and attributes, together with the ability to add pre-workout and post-workout media content allow a customized environment for subscribers. A web-based GUI can be used for querying trainers and to record media that will be heard and/or viewed at the beginning and/or end of a workout or at any other time during the workout. More generally, the subject matter expert modules operate to collect the philosophies of the subject matter expert. Embodiments of the invention, as described previously, are not limited to exercise media content.

Trainers can define methods which involve selecting an exercise and providing attributes. Examples of attributes include frequency (days per week), cadence, reps (number), sets (number), and rest (in seconds). Also, for each method, a range of attributes can be defined by the trainer. For example, the ranges of attributes can include age group (e.g., under 12 years, 12-18, 19-24, 25-32, 33-40, 42-50, 51-60, over 60 years, etc.), a goal (e.g., fat loss, fitness, build muscle, stress reduction, medical, body shaping, activities of daily living, etc.), medical history (e.g., high blood pressure, diabetes, arthritis, cardiovascular disease, high cholesterol, high triglycerides, joint replacement, pregnancy, etc.), experience level (e.g., beginner, intermediate, advanced, etc.), endurance level (e.g., 15 min., 20 min., 30 min, etc.), fitness level (e.g., bad, semi, in shape, etc.), and availability (e.g., 2 days per week (dpw) for 1 hour, 3 dpw/30 min., 5 dpw/30 min., 5 dpw/1 hr, 6 dpw/1 hr, etc.). A GUI presentation including input fields, pull-down menus, and other means for the trainer to define the methods by various exercises and other attributes can be displayed.

As another example, travel agents can define methods which involve selecting an itinerary and providing attributes. Example attributes can include time commitment (e.g., how long it takes to complete the itinerary), location and cost, amongst potentially others. Also, a travel agent can define a range of attributes for each method. For example, these attributes can include age group, available activities (e.g., shopping, museums, skiing, spas, nightclubs, etc.), languages (e.g., English, Russian, Spanish, etc.), available transportation (e.g., train, bus, car rental, plane, etc.), and so on.

A philosophy maintenance page of the website can control training goal, training goal body part, and training goal exercise tables and other data structures to establish a trainer philosophy. For each philosophy, goal, reps, cadence, frequency, and workout length can be defined. For each goal data structure, there can be two lists of data structures, one for body parts (including frequency and ordering) and one for exercises (including frequency).

The data structures created by external SMEs may include scriptlets, such as audio and/or video clips, from any number of external SMEs. In the workout example, each trainer included in the trainer module provides the media clips along with identifiers for associating each media clip with the trainer's philosophies and workout routines. In some cases, one scriptlet may be associated with multiple identifiers. For example, some of the identifiers may identify the trainer, difficulty level, body parts targeted, goal of the exercise, exercise identification, exercise routine segment (i.e., pre-workout, warm-up, body, etc.), suggested frequency, suggested repetitions, cadence, etc. Some scriptlets may also include two identifiers of the same type. For example, one scriptlet may be associated with a warm-up for one difficulty level, and a main exercise for another difficulty level. Similarly, one exercise may target different body parts.

For example, referring to FIG. 3, a particular trainer may be associated with a particular trainer data structure 300. The trainer data structure 300 can include an identifier assigned to the trainer and information describing the trainer's name and system identification. The trainer module can create goal data structures 305 including information associating the goal data structure with a goal identifier, goal name, description of the particular goal, and any aliases associated with the goal. Trainer routine data structures 310 can be created that include information identifying a particular routine. The trainer routine data structures 310 can include information that associates each trainer routine data structure 310 with a trainer identifier, goal identifier, trainer introduction clip identifier, and a workout goal clip identifier for accessing recorded scriptlets, such as audio media clips, associated with the particular routine.

The various data structures disclosed herein can include data stored in tables on a database coupled for access to the data by a server. These tables can include identifiers, descriptive information, associations with other data structures including audio and/or video clips.

Scriptlets data structures can be maintained in a single table and referenced in at various places as set forth herein. Scriptlet attributes can include name (name of scriptlet to be reference within the system), physical file name (actual filename of media, e.g., .mp3 files), step (e.g., preworkout, warmup, exercise, set warmdown, postworkout, etc.), and description (text or description of the scriptlet).

Each routine data structure 310 can be associated with workout templates 315 and weightings data structures 320. Each workout template data structure 315 can include information such as a routine identifier, suggested day information, sequence number information, experience level information, and identifiers for associating the workout template with a particular pre-workout and post-workout recorded scriptlet. The workout template data structures 315 can be associated with a particular experience level data structure 325 that can include an experience level data structure identifier, name of the experience level information, and other descriptive information.

Each workout template data structure 315 can be associated with particular segments 330 and workout activities 335 data structures. The segments data structures 330 can include a segments data structures identifier, information describing the segment's associated workout template and segment name. The segments data structures 330 can also include identifiers of stored scriptlets of recorded media, such as trainer recorded audio to be heard by a subscriber prior to the particular segment or after the segment is performed. Each workout activity data structure 335 can include a workout activity identifier, information describing the workout template associated with the particular workout activity, and information describing a sequence of workout segments associated with the particular workout activity data structure 335.

Each workout activity data structure 335 can be associated with various activities data structures 340. Each activities data structure 340 can include an activity data structure identifier and information describing the associated activity's name, exercise category, intensity, cadence, volume, reps, rest length, and an identification of an intensity progression media scriptlet. Each of the routines 310 and activities 330 data structures can also be associated with particular weightings data structures 320, which can include weightings data structure identifiers, associated routine identifiers, associated activities identifiers, associated exercise identifiers and a description of the weighting.

The various trainer data structures illustrated in FIG. 3 can be generated using inputs from a particular trainer accessing a web application, such as the trainer module 108 of the web application 105 of FIG. 1. The trainer module 108 can query the particular trainer for training goals and associate these training goals to generate goal data structures 305 with trainer specified routines to create routine data structures 310, workout templates to create workout template data structures 305, experience levels to create experience level data structures 325, workout templates to create workout template data structures 315, and so on to generate the various data structures of FIG. 3.

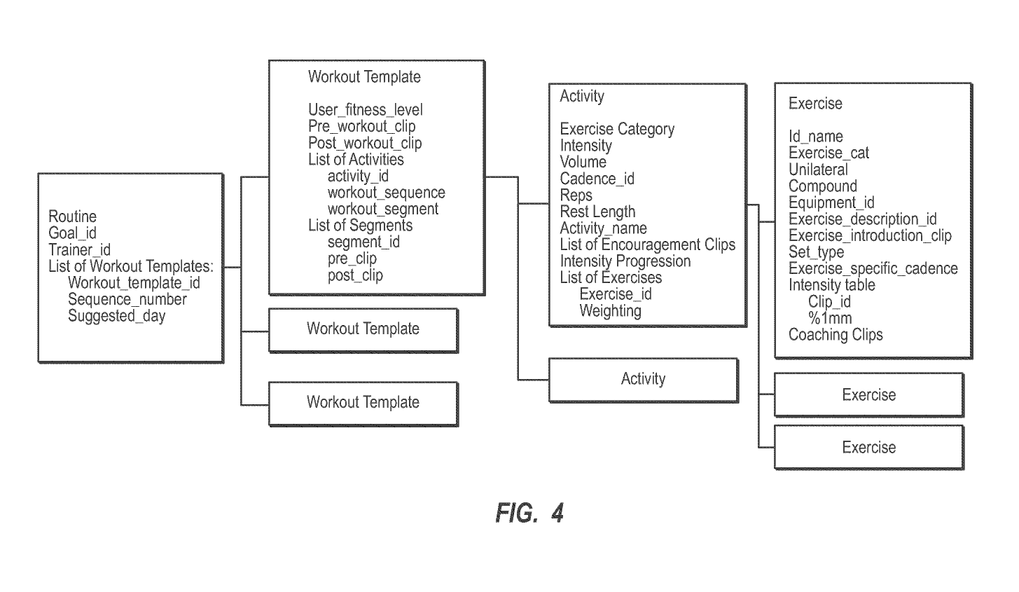

Referring to FIG. 4, a block diagram example illustrating various data structures that contain information about a trainer's philosophies as they relate to goals (e.g., lose weight, build muscle, etc.), workout sequences, activities, and exercises, (i.e., for each trainer's goal, there are many workout templates/sequences, for which there are many activities, for which there are many exercises). The model illustrated in FIG. 4 consolidates information that is shareable between data structures and ensures there is only one instance of the shared (or common) information. In other words, there need not be a whole set of exercise and activity definitions for each trainer but rather data structures can include identifiers associating them with other data structures.

In one example, types of available exercises and activities don't vary from trainer to trainer, so exercise and activity data is “common” information, which only exists one time for each kind of exercise and activity. However, special attributes that are different from trainer to trainer can be maintained specifically for each trainer separate from the “common” activity and exercise data structures. This architecture can reduce the amount of information required to be captured by each trainer. Thus, only the data structures that change from trainer to trainer need be stored. The “common” information can be maintained in the information management module 110 of FIG. 2 so that the data does not have to be replicated.

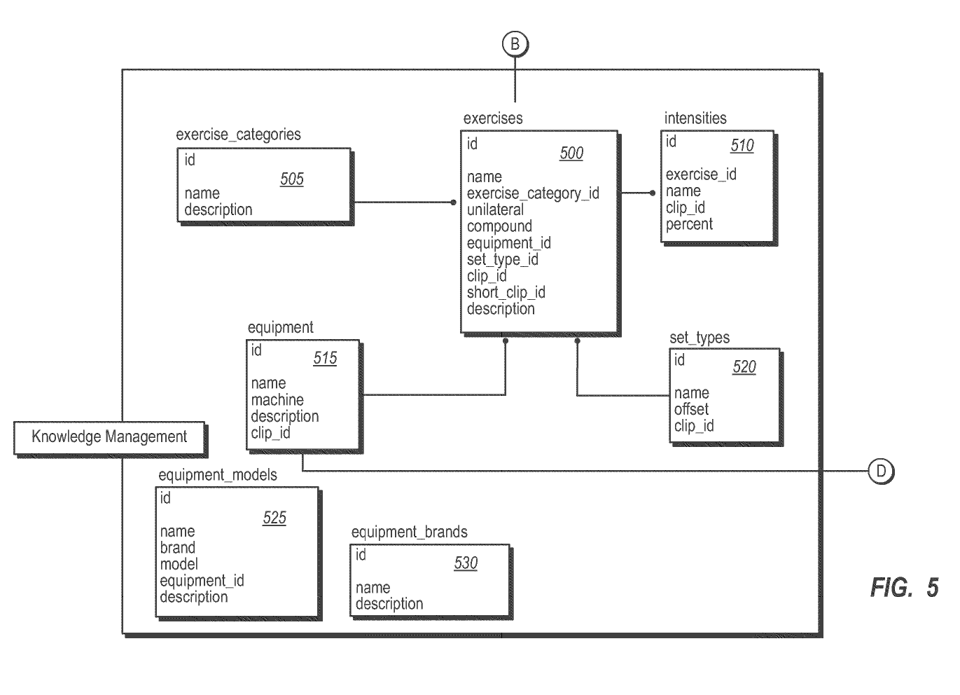

Referring to FIG. 5, various exercise related data structures are illustrated that are associated with the various activities data structures 340 of FIG. 3. Each exercise data structure 500 can also be associated with a particular exercise category data structure 505 and intensity data structure 510. The exercise data structure 500 can include an exercise identifier and information describing a name of the exercise and type of exercise and associated exercise category, equipment, and set type data structures. The exercise data structure 500 can also identify associated clips to be included in the subsequently generated individualized media.

Each exercise data structure 500 can be associated with particular equipment 515 and set type data structures 520. The set type data structure 520 can include a set type identifier, information describing the set, and identification of an associated media clip.

Each equipment data structure 515 can include an equipment data structure identifier and information describing the name, machine, and descriptive information of the equipment. The equipment data structure 515 can also include an identification of a media clip associated with the particular equipment data structure. Additional data structures that may be included and associated with the equipment data structure illustrated in FIG. 5 are equipment model data structures 525 and equipment brand data structures 530.

The various data structures illustrated in FIG. 5 can be generated by the exercise information module 180 of FIG. 2. The data structures of FIG. 5 can be generated by a knowledge engineer responding to queries using a web based application such as the web based application 105 of FIG. 1. The knowledge engineer can create the various exercise data structures 500 as a set of options for selection by trainers and subscribers using the web based application 105. After the data structures of FIG. 5 are generated by the knowledge engineer, the various exercises defined by the exercise data structures 500 can be offered to the trainers using the web based application 105 to associate the various exercises with the routines, workout templates, segments, and activities selected by the trainer for a particular goal. Thus, the exercises data structures 500 of FIG. 5 can be the available building blocks for particular routines created by trainers using the trainer module 108 of the web application 105 to later generate media that satisfies a particular goal of a subscriber.

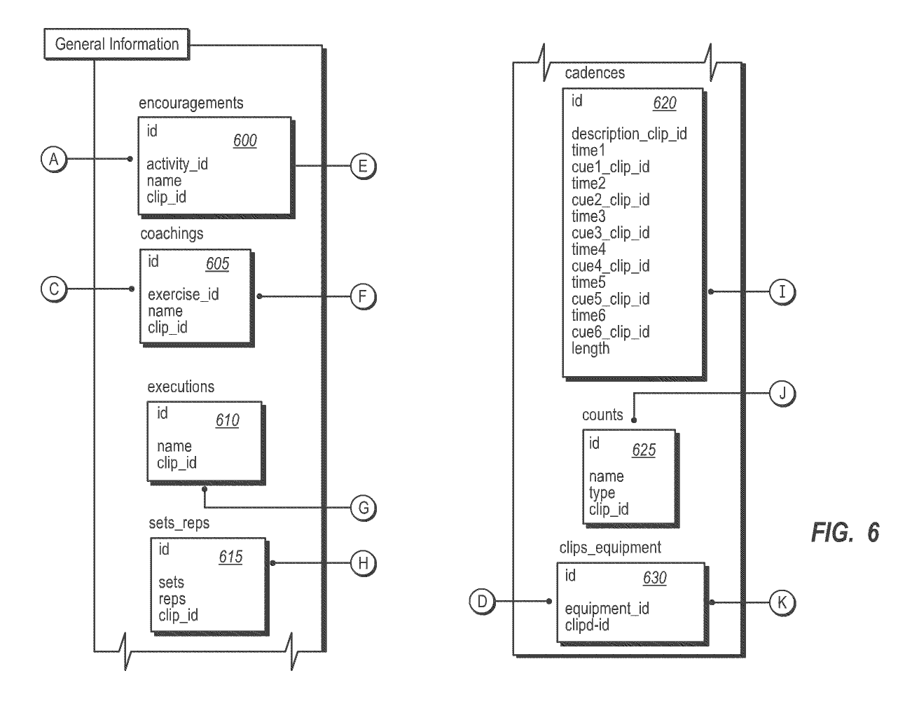

Referring to FIG. 6 various general information data structures are illustrated that can be associated with the exercise data structures of FIG. 5. For example, the data structures of FIG. 6 can be some of the building blocks for generating the media files associated with each of the exercise data structures of FIG. 5 and routine and activity data structures of FIG. 4. As shown in FIG. 6, encouragements data structures 600 can be associated with particular activity identifiers and can include clip identifiers associating the encouragements data structures 600 with particular media scriptlets.

Coaching data structures 605 can include exercise identifiers associating the coaching data structures 605 with particular exercises data structures 500 from FIG. 5. The coaching data structures 605 can include a coaching data structure identifier, name, and other identifiers associating the coaching data structure 605 with an associated media clip and exercise. Thus, coaching media clips can include rules associating them with particular exercises based on the coaching data structures 605.

Executions 610, sets reps 615, cadences 620, and counts 625 data structures can be associated with various media clips for the various exercises. The cadence data structures 620 relate to the portion of a workout where exercises are actually being executed. Cadence refers to the timing and pace of the execution (i.e., the counting, and format of the counting) for a particular exercise. Thus, the executions, sets, reps, cadences, and counts all combine to control the selection of media clips to control the timing, pace, repetitions, etc for each exercise. Clip equipment data structures 630 can also be generated for associating the particular equipment used, with associated media clips to be included in the individualized media generated.

The data structures illustrated in FIG. 6 can be generated using knowledge expert inputs to the knowledge expert module of the web application 105 of FIG. 1B. Thus, the knowledge expert can create the general exercise data 190 of FIG. 2 by creating the encouragement 600, coaching 605, execution 610, sets-reps 615, cadences 620, counts 625, and equipment 630 data structures illustrated in FIG. 6 using a web-based GUI and associating these data structure building blocks with particular exercise data structures illustrated in FIG. 5. Thus, the exercises selected by trainers that makeup particular routines and workout templates associated with particular subscriber goals can be made of, in part, the data structures of FIG. 6.

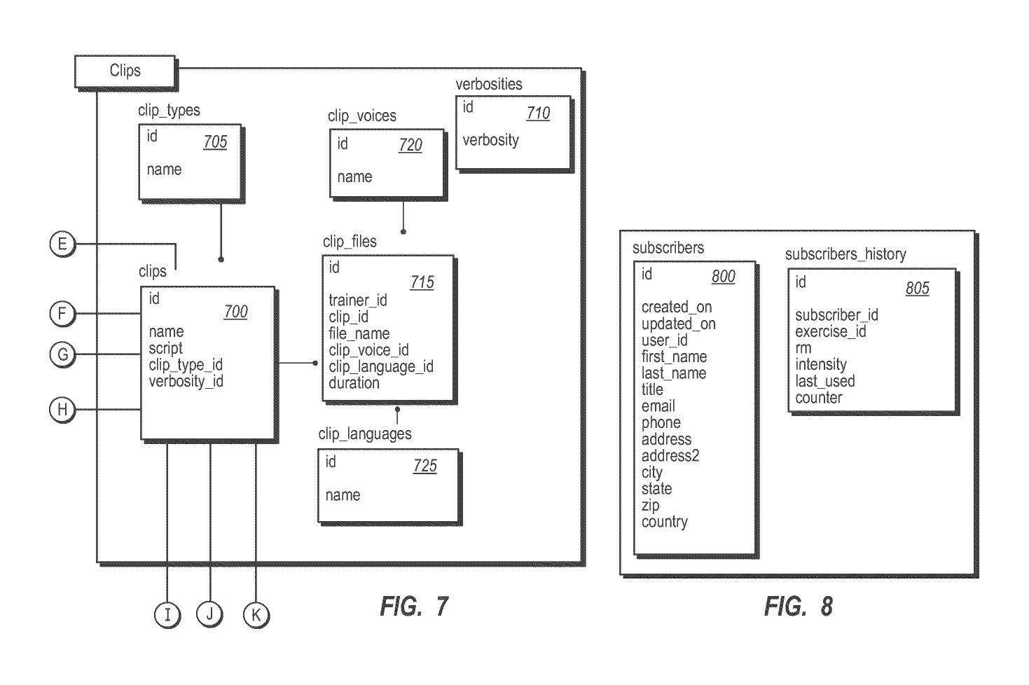

Referring to FIG. 7, various data structures for associating media clips with the data structures of FIGS. 4, 5, and 6 are illustrated. Clips data structures 700 can include a clip identifier that is associated with the various data structures of FIGS. 4, 5, and 6. The clips data structures 700 can also include information associating the clip data structure 700 with a clip type 705 and verbosity 710 data structure along with information describing the name of the clip and script. Clip files data structures 715 can include trainer, clip, clip voice and clip language identifiers for associating the clip files data structures 715 with particular trainer 300, clip 700, clip voice 720, and clip language 725 data structure. The clip types 705, clip voices 720, verbosities 710, and clip languages 725 data structures can be associated with the clip files data structures 715 in order to tailor to the media files selected to the particular subscriber for which the individualized media is generated.

Referring to FIG. 8, various data structures describing subscribers are illustrated. The data structures illustrated in FIG. 8 can be generated by receiving inputs from subscribers and other sources to the subscriber module 109 of the web application 105 illustrated in FIG. 1B. The different types of inputs are illustrated in FIG. 1C. Subscribers' data structures 800 can include a subscriber's data structure identifier and information describing various attributes of the particular subscriber. Subscribers' history data structures 805 can include a subscriber history data structure identifier and subscriber and exercise identifiers associating the subscriber history data structure 805 with subscribers 800 and exercise 500 data structures. The subscribers' history data structure 805 can also include information describing actions and preferences of the subscriber, and can be modified in real time by real time inputs. Thus, the subscribers 800 and subscribers' history 805 data structures can represent at least a portion of the subscriber attribute information 130 of FIG. 2.

The information collected directly from a subscriber and devices associated with the subscriber may be information collected when the subscriber initially logs onto the web application of FIG. 1B, may be updated over time and/or may be collected continuously or semi-continuously in real time while a subscriber is experiencing media content. During an initial subscription to the web application 105, the subscriber may be queried for a variety of personal information by the subscriber module 109 of the web application 105 of FIG. 1. Information queried may include, for example, age, weight, preferred physical exercise, preferred type of physical workout, gender, level of physical fitness, desired level of physical fitness, music genre preference, any medical conditions, identification of a preferred trainer, language preference, nationality, geographical location, knowledge of physical fitness equipment, and access to physical fitness equipment.

As another example, the media content in question may relate to cooking/nutrition, rather than exercise. In this case, information queried may include some or all of the information queried in the exercise example. Additionally or alternately, queried information may include desired weight (e.g., for weight loss/gain purposes), preferred type of food (e.g., Italian, Chinese, Mediterranean, etc.), desired preparation time, identification of a preferred chef, desired number of servings, amongst potentially other queried information.

In some embodiments, the individualized information may also include for example, a date the user's individualized information was entered, a date the user's individualized information was updated, a user identification number, the user's name, the user's title, the user's e-mail address, the user's address, and other personal information about the user.

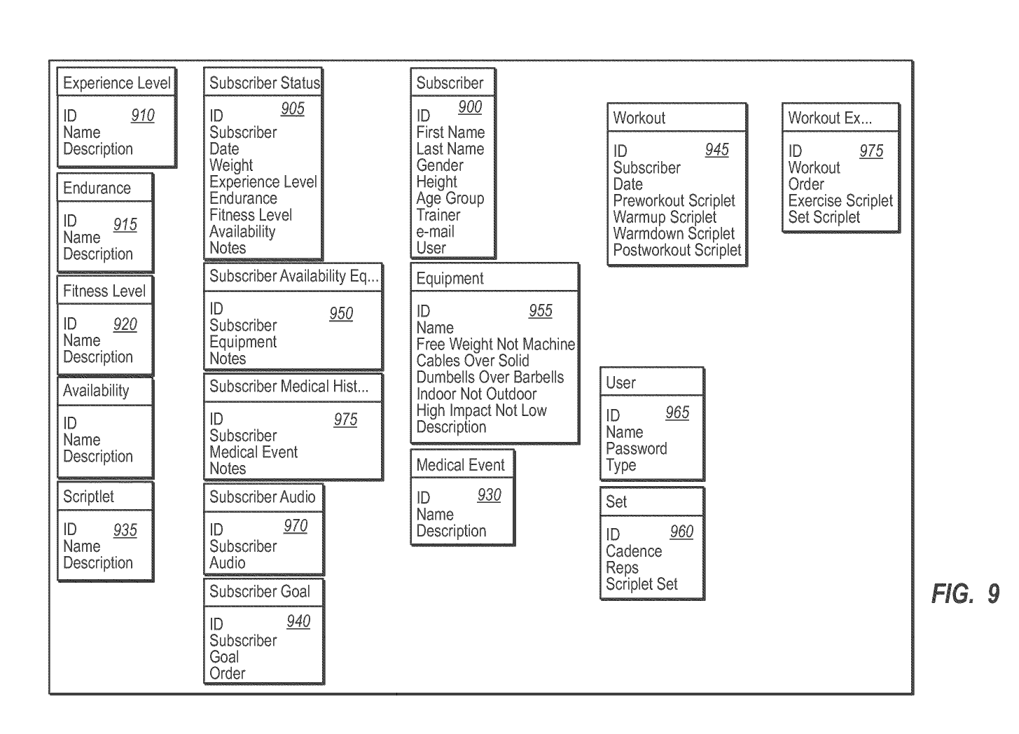

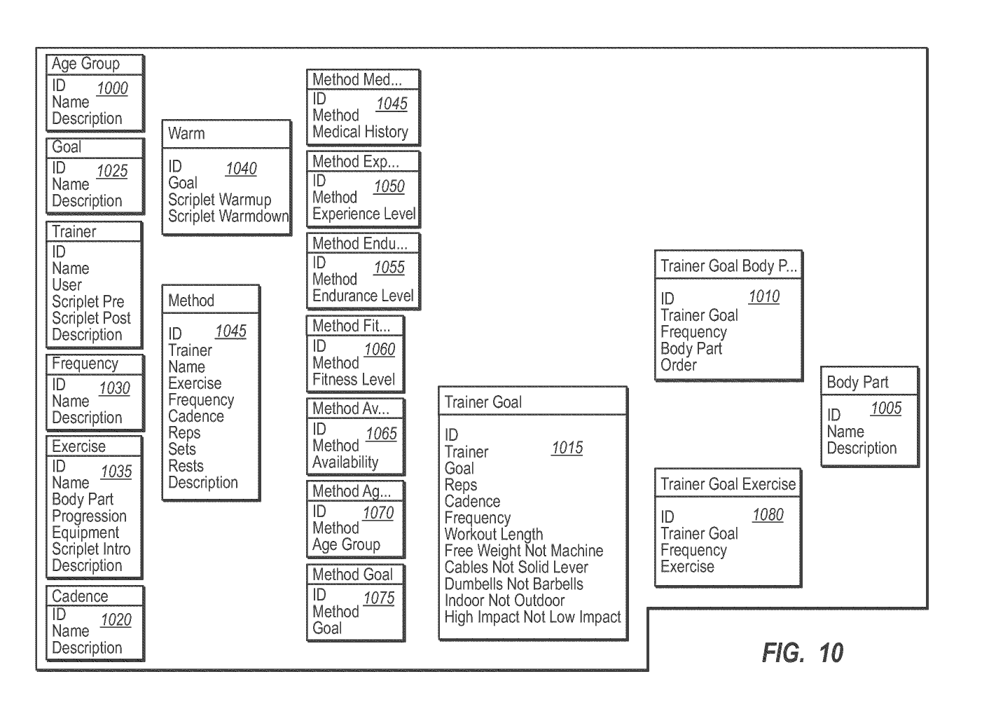

Referring to FIGS. 9 and 10, various data structures are illustrated that can be generated by the knowledge based module 120 of FIG. 2 by associating subscriber 800 and subscriber history 805 data structures generated by the subscriber module 109 with the data structures generated by the knowledge expert module 107 and trainer module 108 of the web application 105 illustrated in FIGS. 1 and 3-8 to generate and compile the individualized media scriptlists.

Referring still to FIGS. 9 and 10, various data structures are illustrated that may be generated and associated based on a subscriber's response to various queries. Based on the subscriber's response to the queries, associated subscriber 900 and subscriber status 905 data structures can be generated and associated with experience level 910, endurance 915, fitness level 920, subscriber medical history 975, and medical event 930 data structures that describe the physical abilities of the particular subscriber. Endurance data structures 915 list at least one of all possible endurance designations used in the subscriber's status table, identifying how long they were able to workout. Experience level 910 data structures list at least one of all possible experience level designations and are used to match a subscriber's stated experience and specific exercise requirements. The Fitness level data structure 920 lists at least one of all possible fitness levels used to match subscriber's stated fitness level and specific exercise requirements (in the method table). The medical event data structure 930 lists at least one of all possible medical events a subscriber can select (defining historical medical conditions, etc.) and are used to match against trainer methods data structures (e.g., see FIG. 10).

The data structures of FIG. 9 can be modified and/or other data structures may be generated based on real time inputs. For instance, if a user provides real time feedback that a workout is too hard or too easy, the fitness level designation within the fitness level data structure 920 could be appropriately adjusted upwards or downwards. Similarly, real time user feedback that an exercise is too long or too short might result in an upwards or downwards adjustment of the endurance level designation within the endurance data structure 915. Alternately or in addition, a real time data structure could be generated that includes some or all of the real time inputs.

These subscriber descriptive data structures can be associated with various data structures generated for a subscriber, such as scriptlets 935, subscriber goals 940, workout 945 subscriber availability equipment 950, equipment 955, set 960, user 965, subscriber audio 970, and workout exercise 975 data structures to tailor the individualized media to the particular needs of the subscriber. The subscriber availability data structure 950 can list all possible exercise availability options (time commitment) used to identify what a subscriber's time availability is for matching the subscriber with media clips. Equipment data structures 955 list at least one of all possible equipment used in exercises and a subscriber's equipment availability designations. The subscriber goal data structure 940 lists at least one of all possible fitness goals a subscriber can select, and are used to match against trainer methods data structures. The workout exercise data structure 975 lists at least one of all possible exercises used in the system, which Trainers define their methods around. The scriptlet data structure 935 maintains all audio clips (or scriptlets), which can be physical mp3 files. This table identifies the physical file name, and further identifies its type. The set data structure is used to identify which scriptlet to use for counting through an exercise, given its cadence and reps. All of this information can be used to associate the subscriber with a particular trainer, goals, routines, activities, exercises, and so on, such that a scriptlist can be created that identifies scriptlets of media clips for inclusion in an individualized media clip.

Referring to FIG. 10, additional data structures that can be associated with a particular subscriber to match the subscriber with methods, goals, exercises and other trainer data structures are illustrated. An age group data structure 1000 associates the subscriber with one of several possible age groups used throughout the system for generating the individualized media. A body part data structure 1005 lists all body parts used to identify exercise localizations and can be associated with a trainer goal body part data structure 1010 and as a result a trainer goal data structure 1015 to match body part exercises with a trainer's methodologies. A cadence data structure 1020 lists at least one of the possible speed or cadence options to define how the exercise counting is to be done, which is used in method and set data structures.

Additional trainer designated data structures can include goal 1025, frequency 1030, exercise 1035, and warm 1040 data structures. Warm data structure 1040 attributes can define which warm-up and warm-down scriptlets to select. For example, there can be goals (e.g., fat loss, fitness, build muscle, stress reduction, medical, body shaping, sport specific, activities of daily living, etc.), step (preworkout, warmup, exercise, set warmdown, postworkout, etc.), scriptlet warmup (e.g., “Warm-up” recorded media), and scriptlet warmdown (e.g., “Warm-down” recorded media).

A method data structure 1045 along with various trainer method data structures can also be generated. For example there can be method medical condition 1045, method experience level 1050, method endurance 1055, method fitness 1060, method availability 1065, method age 1070, method goal 1075, and trainer goal exercise 1080 data structures that are generated in response to trainer query responses submitted to trainer module 108 of web application 105 illustrated in FIG. 1B.

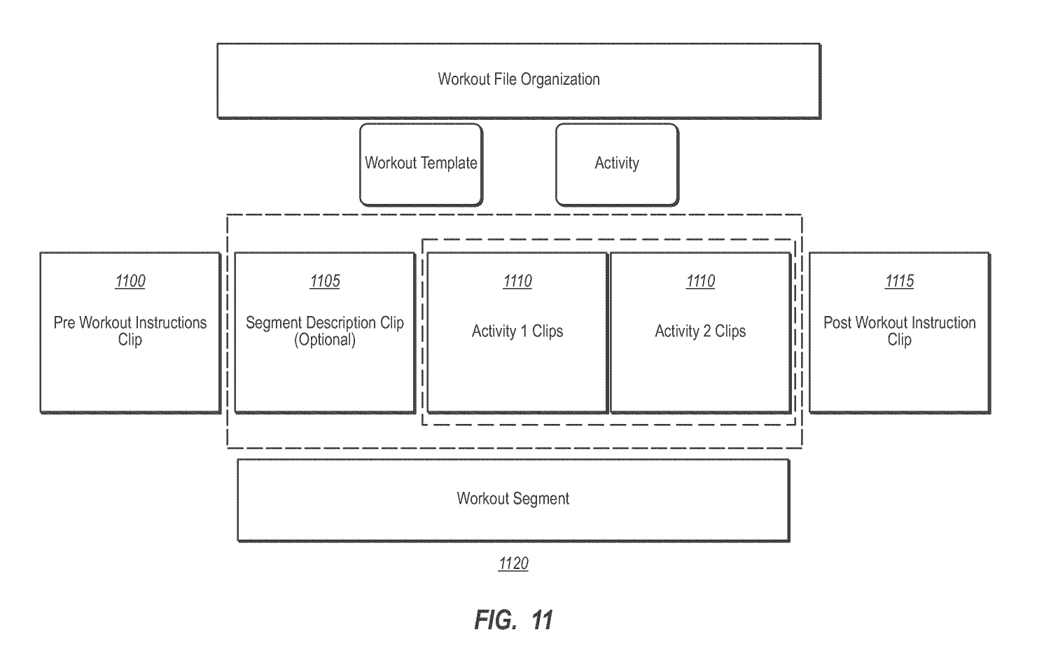

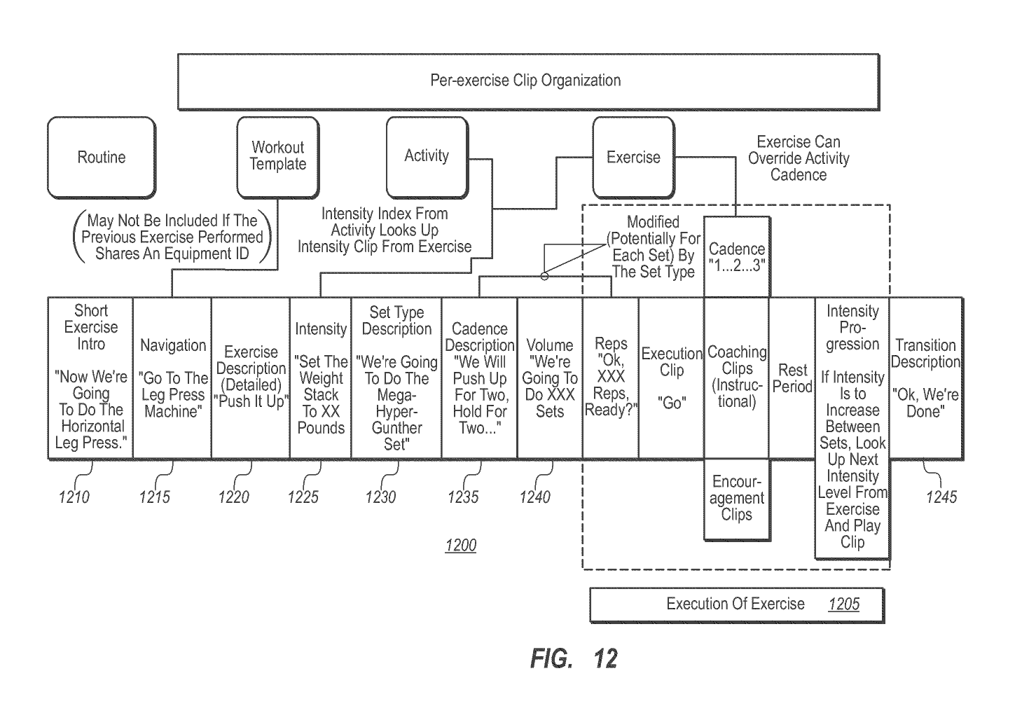

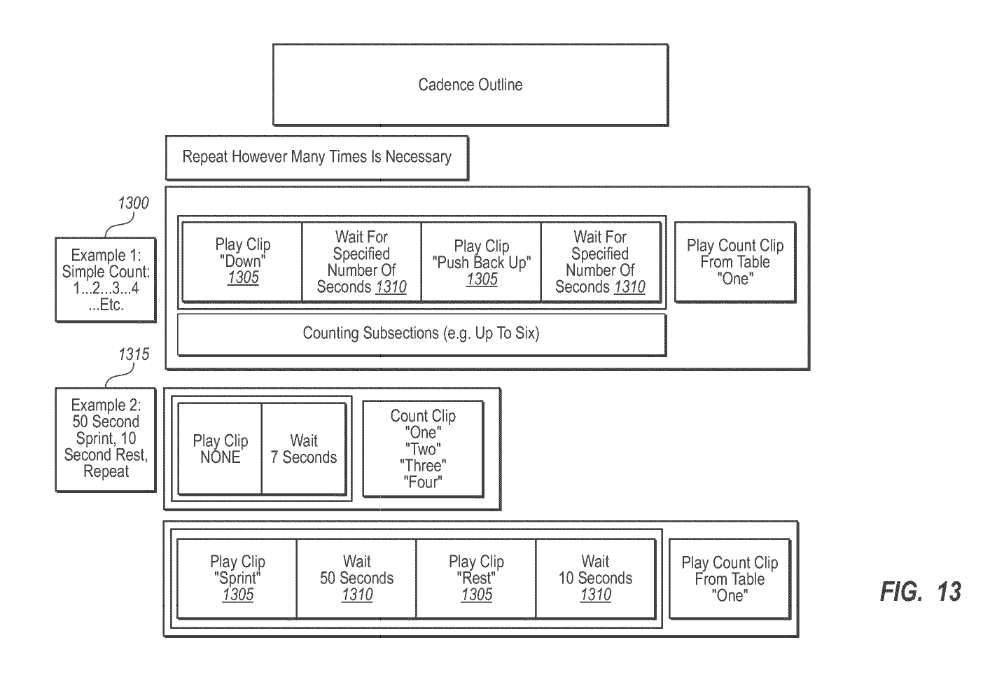

FIGS. 11-13 illustrate examples of the contents of a workout file, which is one example of media content. The workout file can be self-contained as a complete workout clip or it can be streamed to a subscriber. FIG. 11 is a broad overview of a workout file 1120. FIG. 12 is a more detailed view of the contents of an exercise portion of the workout file 1120. And FIG. 13 is a detailed view of cadence examples in the workout file 1120.

The workout file 1120 can be composed of various scriptlets selected by logic module 150 in FIG. 2 for example. Logic module 150 may select scriptlets to create a complete workout file 1120 according to the methods illustrated in FIG. 2. For example, referring to FIG. 11, a complete workout file 1120 may contain pre-workout instruction scriptlets 1100 (such as “This Workout Will Give You Abs of Steel”), segment description scriptlets 1105 (such as “We Will Now Perform Sit-Ups”), exercise (activity) scriptlets 1110 (such as “Up, Down, Up, Down”), post-workout scriptlets 1115 (such as “Go Get Some Water”), and pause scriptlets (not shown, but can be inserted as needed), etc. Cadence scriptlets may be used to affect the difficulty, speed, repetition, etc., of a workout. These scripts can be organized as discussed above, to include a preworkout introduction warm-up, exercise, introduction, sets, warm down, and post workout conclusion. The workout file 1120 can use the trainer designed and subscriber matched workout templates and activities discussed above to select the individual scriptlets that match the subscriber's goals and profile attributes. Of course other embodiments of the file 1120 can include fewer or more scriptlets. Alternatively, some of the scriptlets or segments can be combined.

While the file 1120 of FIG. 11 is illustrated as a workout file, the file 1120 and variations thereof can easily be adapted to accommodate media content relating to other subject matter. As one example, the file 1120 may represent a lecture file. In this example, the lecture file 1120 may contain pre-lecture instruction scriptlets 1100 (such as “This lecture covers topics A, B and C”), segment description scriptlets 1105 (such as “We will now begin discussion of topic A”), topic scriptlets 1110 (explaining topics A, B and C), post-lecture scriptlets (such as “Review topics A, B and C by answering the following questions . . . ”) and/or pause scriptlets. Additionally, the different clips 1100, 1105, 1110 and 1115 can be omitted and/or rearranged as desired.

According to one embodiment of the invention, the workout file 1120 is generated and the identified scriptlets (e.g., pre-workout instructions scriptlets, exercise scriptlets, etc.) are fed a few at a time (or one clip at a time) to the media creation module 160 where they are mixed and streamed to a subscriber at real-time, meaning while the user is experiencing the media. While the subscriber is experiencing the content, subscriber history data structures may be modified by real time input from the subscriber and/or devices associated with the subscriber. In response, the workout file 1120 may be modified compared to the originally generated workout file. That is, the logic module 150 may disregard the previously selected scriptlets or scriptlet clips (e.g., clips 1100, 1105, 1110 and 1115) and select new ones. Scriptlets or scriptlet clips for the newly modified workout file 1120 can then be mixed and streamed to the subscriber. Advantageously, this provides an adaptable workout that is responsive to dynamic subscriber information.

Referring to FIG. 12, a more detailed example of a per-exercise clip portion 1200 of workout file 1120 is illustrated. The per-exercise clip 1200 may correspond to the activity clips 1110 of FIG. 11. Per-exercise clips can be organized according to the template illustrated in FIG. 12 and the particular scriptlets can be selected based on the routines, workout templates, activity, and exercise data structures matched with the subscriber's profile attributes and goals using the trainer methods. The subscriber can also select a particular trainer, which can be an attribute of the subscriber and used to match the subscriber with particular scriptlets. The subscriber can also be matched with the particular trainer based on the subscriber's goals, health, available equipment, and/or any other attributes of the subscriber. For example, where the subscriber has a particular health issue the subscriber can be matched with a particular trainer with goals and training philosophies tailored for the particular health issue of the subscriber. Subsequently the trainer's method data structures and scriptlets can be matched to the subscriber to create the individualized media program for the individual subscriber.

As indicated in FIG. 12, an exercise portion 1205 of the assembled per-exercise clip 1200 may only consist of a portion of the overall per-exercise clip 1200. Other portions of the per-exercise clip 1200 may be included as shown, such as introductions 1210, navigations 1215, exercise descriptions 1220, intensity clips 1225, descriptions of the set type 1230, cadence description describing the pace 1235, volume description 1240, and transition descriptions 1245. Thus, there can be scriptlets that have been matched with the subscriber that give detailed information and introduction to all aspects of the individualized workout for the subscriber. The scriptlets may include information from trainer information module 170, exercise information module 180, and general information module 190 of FIG. 2. Each of the trainer information 170, exercise information 180, and general information 190, correlate with the content of an individual scriptlet.

Referring to FIG. 13, more detailed block diagrams of various clips making up two example cadence outlines are illustrated. Example 1 illustrates a simple cadence outline for a simple count type of exercise. As illustrated the cadence clip can include various instruction clips 1305 interposed with various pause 1310 clips. The duration of the various instruction clips 1305 and pause clips 1310 can be dependent on any variable in the system. For example, the type of exercise, philosophies of the trainers, and attributes of the subjects can be matched with different instruction clips 1305 and pause clips 1310 to control the pace and timing of the exercise according to the cadence example clips shown in FIG. 13.

The cadence clips can include more detailed instructions tailored to any aspect of an individualized media program. The cadence clips can include instructions that are tailored to the type of exercise, goals, subscriber attributes, trainer, etc. Example 2 1315 illustrated in FIG. 13 shows a block diagram of a sprint-rest cadence clip for a particular exercise. As shown, the instruction clips 1305 and pause clips 1310 durations are tailored for the particular type of exercise and duration of activity that is conducted in response to the respective instruction according to this example.

Referring again to the example process of FIG. 2, the logic module 150 selects, organizes, and arranges a scriptlist of scriptlets according to the information for each scriptlet to create a complete media content file, such as the files illustrated in FIGS. 11-13, with the appropriate amount of scriptlets in the appropriate order according to the desired media content. As discussed above, the file is associated with personal information, external SME (e.g., trainer, chef, professor, travel agent, etc.) information, internal SME information (e.g., exercise information, general information, etc.) to create a stream or self-contained clip specifically personalized to the individual subscriber. When streamed, the file can also be dynamically modified in response to real time input.

The scriptlist generated contains a list of identifying information for each scriptlet necessary to produce the file (e.g., see FIG. 11). Media clip creation module 160 uses the information from the scriptlist to retrieve the appropriate scriptlets from the appropriate modules and databases storing the scriptlets, and combines, or mixes, the individual scriptlets according to the scriptlist to create a complete clip. Alternately, media creation module 160 uses information from the scriptlist to retrieve a few of the scriptlets at a time, mixes the retrieved scriptlets and provides a stream to a subscriber. Media clip creation module 160 may also use media supplied by the subscriber 140 to mix a complete clip with background music selected by the subscriber 140, further personalizing the media clip. Music may, however, be selected by any entity of the system, such as subscriber, external SME, and internal SME.

A file can be streamed a portion at a time to the subscriber 140 and/or a complete clip may be stored on the subscriber's computer, accessible by the subscriber 140, and may be associated with a specific media organization program such as itunes®, or other similar software, for download of music files to a personal media device such as an ipod®, .mp3 player, or other electronic device. A file may then be experienced by user 140 to guide or assist with an activity (e.g., a workout, studying, tour of a museum, etc.). It should be appreciated that individualized video clips and combined video and audio clips of any format can also be assembled using the teachings set forth herein.

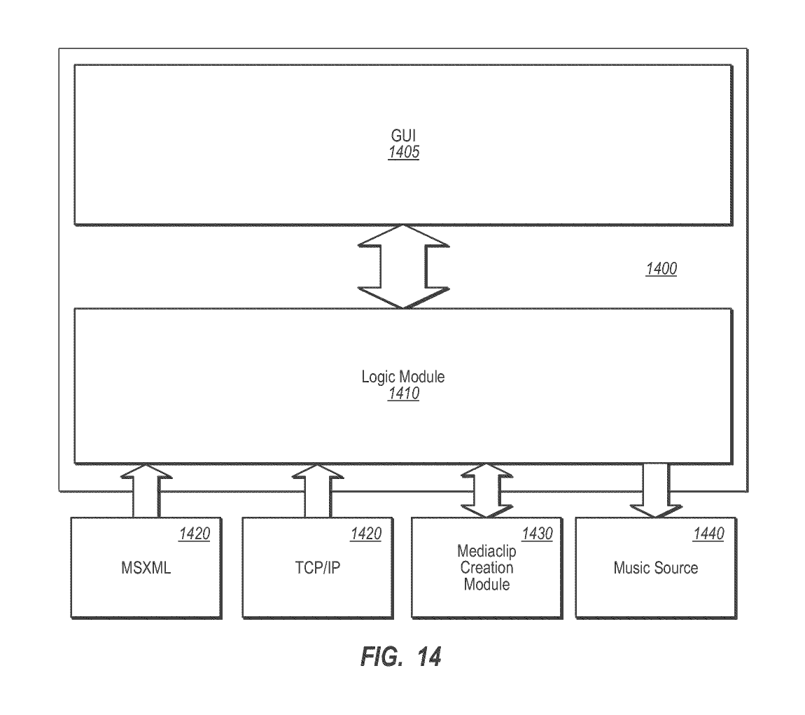

FIG. 14 illustrates a control flow schematic of the interaction between a subscriber and a system for performing the methods discussed herein. In one embodiment, the subscriber may access a computer running subscriber software 1400. As illustrated, a “GUI” 1405, which is a pluggable skin (a graphical representation displayed on a monitor connected to a computer running subscriber software 1400 such as the interactive GUI of subscriber module 109 illustrated in FIG. 1), may be modified by each subscriber. Communicating with the GUI 1405 is a logic module 1410. Logic module 1410 may perform all or a portion of the functions performed by logic module 150 in FIG. 2. Subscriber software 1400 may communicate with knowledge base module 120 of FIG. 2 and the internet through interfaces, such as a TCP/IP interface 1420. Media clip creation module 1430, which can be Bassell from Unseen Developments for example, mixes the media clips received according to the scriptlist. A music source 1440, such as an itunes object interface with itunes®, provides the music for mixing with the individualized media. In some embodiments, a workout file may be designed specifically for a type of exercise enjoyed by a subscriber, such as running, weight lifting, yoga, pilates, etc., and may be performed at any time and in any place convenient and suitable for the exercise.

Example embodiments disclosed herein provide for methods and systems that are configured to overcome various deficiencies of current information aggregation and dissemination methods, systems, media, and computer program products.

Various embodiments of the invention comprise a method of creating individualized content media. The method may include the steps or acts of receiving individualized information from a subscriber, associating each of a plurality of digital media scriptlets with scriptlet identification information, and processing the individualized information in a knowledge base module. The knowledge base module may access the scriptlet identification information. The method may further include the steps of creating a clip list based on the individualized information, and making media files associated with the clip list available to the subscriber.

In several embodiments, the system queries entities such as internal and external subject matter experts as well as subscribers for information. The information received in response to the queries is captured and managed and can be classified as “common” information (e.g., pre-defined knowledge engineering content), internal SME or “trainer” content (e.g., trainer philosophy, goals, and methods), and subscriber attribute information (e.g., ongoing and historical attributes for a particular subscriber). The system can query these entities via online webpages and store the information received from these entities in databases coupled to a server hosting the webpages. Administration webpages can also be hosted by the server allowing for administrative maintenance and reconfiguration of the knowledge based systems and other webpages hosted by the server.

The system then generates a file sequence based on matching of the stored information. This file sequence can be embodied by a scriptlist of scriptlets that include clips of audio and/or video clips that can be later requested and downloaded by a subscriber, using their home computer for example, and downloaded to a portable media player device. Alternately, the file sequence including clips can be streamed to the subscriber, and the file sequence can be dynamically modified or changed in response to real time input about the subscriber. Music selected by the subscriber can also be mixed with the audio and/or video clips, using software executed on the subscriber's computer for example, to overlay the audio and/or video clips with the subscriber's favorite music.

The processing may include filtering the scriptlet identification information based on the individualized subscriber attribute information. A clip list may also be created from the filtered scriptlet identification information by applying logic based on the individualized information. In some embodiments, at least one of the media clips may include any one of lecture instructions, cooking instructions and travel instructions. In other embodiments, at least one of the media clips may include workout instructions. The workout instructions may be associated with at least one of pre-workout, warm-up, exercise, exercise introduction, exercise set, warm-down, and post-workout.

Alternately or additionally, the scriptlet identification information may include information relating to an associated physical workout, cadence of a physical workout, intensity of a physical workout, an associated physical exercise, an associated muscle group, an associated exercise category, repetitions of a physical activity, identification of a person recorded, genre of music, rest length, clip length, intensity of progression of a physical workout, and/or relative volume. Each of the media clips may include recorded information relating to at least one of: an associated physical workout, cadence of a physical workout, intensity of a physical workout, an associated physical exercise, an associated exercise category, repetitions of a physical activity, identification of a person recorded, rest length, and intensity of progression of a physical workout.

In some embodiments, the processing may include assigning a weighted value to each of the scriptlets depending on the individualized subscriber attribute information. The individualized subscriber attribute information may include information relating to: age, weight, preferred physical exercise, preferred type of physical workout, gender, level of physical fitness, desired level of physical fitness, music genre preference, any medical conditions, identification of a preferred trainer, language preference, nationality, geographical location, knowledge of physical fitness equipment, and access to physical fitness equipment. In some embodiments, the individualized subscriber attribute information may also include: a date that the subscriber's individualized information was entered, a date that the subscriber's individualized information was updated, a subscriber identification number, the subscriber's name, the subscriber's title, the subscriber's e-mail address, the subscriber's address, and other personal information about the subscriber. In some other embodiments, the individualized subscriber attribute information may also include a history associated with the subscriber's workout and exercise use, including real time information about the subscriber while the subscriber is experiencing media content.

In some embodiments, the associating of each of a plurality of digital media scriptlets with scriptlet identification information may include evaluation and/or creation of the content of at least one of the plurality of digital media scriptlets by an internal or external subject matter expert such as a knowledge expert, professor, chef, travel agent, personal trainer or other knowledgeable professional. Some embodiments may also include mixing the media scriptlets with audio files provided by the subscriber. The media may be video and/or audio.

Some embodiments of the invention may include a system for creating individualized content media. The system may include a database, which may include a plurality of scriptlets. The system may also include a knowledge base module configured to receive individualized information from a subscriber. The knowledge base module may include, for example, a data-query function configured to determine an appropriate selection group of scriptlets from the database, and a rules function configured to create a clip list associated with the appropriate selection group.

In some embodiments, the system may include a mixer configured to mix the scriptlets with audio files provided by a subscriber. The mixer may alternately or additionally stream media content to the subscriber. In other embodiments the system may include a user-interface configured to provide the individualized content media to the subscriber. The media may include, for example, audio and/or video data clips.

The embodiments described herein may include the use of a special purpose or general-purpose computer including various computer hardware or software modules, as discussed in greater detail below.

Although more specific reference to advantageous features are described in greater detail above with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The embodiments described herein may also be described in terms of methods comprising functional steps and/or non-functional acts. Some of the previous sections provide descriptions of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the previous description of the flow diagrams—is used to indicate the desired specific use of such terms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method of dynamically creating individualized media content for a subscriber, the method comprising:
processing individualized subscriber attribute information in a knowledge base module, wherein the knowledge base module includes pre-defined content, including media clips;
comparing the subscriber attribute information with metadata describing the pre-defined content to identify one or more media clips that match the individualized subscriber attribute information;
creating a clip list including the one or more media clips based on matching media clip identification information; and
streaming the clip list to a content player associated with the subscriber such that the subscriber can experience the clip list as it is being streamed.

2. The method of claim 1, further comprising
receiving the individualized subscriber attribute information from the subscriber; and
storing the individualized subscriber attribute information in a computer readable medium.

3. The method of claim 2, wherein the individualized subscriber attribute information includes fitness goals of the subscriber.

4. The method of claim 3, wherein the individualized subscriber attribute information further includes:
an age group of the subscriber;
availability of the subscriber;
a fitness level of the subscriber;
an experience level of the subscriber;
a medical attribute of the subscriber;
an age of the subscriber;
a weight of the subscriber;
a preferred physical exercise of the subscriber;
a sex of the subscriber;
a trainer preference of the subscriber;
a language attribute of the subscriber;
a nationality attribute of the subscriber;
a geographical location of the subscriber; and
a physical fitness equipment accessible to the subscriber.

5. The method of claim 1, wherein the one or more media clips include workout instructions.

6. The method of claim 5, wherein the one or more media clips include one or more of a pre-workout clip, warm-up clip, exercise clip, set clip, warm-down clip, or a post-workout clip.

7. The method of claim 1, wherein the individualized subscriber attribute information includes historical attributes associated with the subscriber's workout and exercise use, including one or more of a subscriber identification number, exercise identification information, workout intensity information, and information relating to the frequency of use.

8. The method of claim 1, wherein the individualized subscriber attribute information includes subscriber information received from one or more of the content player and one or more other devices associated with the subscriber, the subscriber information being received while the subscriber is experiencing the streaming clip list.

9. The method of claim 8, further comprising, in response to receiving the subscriber information, modifying a portion of the clip list that has not been streamed to the content player.

10. The method of claim 8, wherein the one or more other devices associated with the subscriber include one or more of a heart rate monitor, a treadmill and other device, or a user interface through which the user provides real-time feedback.

11. The method of claim 8, wherein the subscriber information includes one or more of subscriber feedback, workout results and real time activity.

12. The method of claim 1, further comprising mixing the one or more media clips with an audio file provided by the user.

13. The method of claim 1, wherein the one or more media clips includes at least one of audio files or video files.

14. A system for creating individualized media content, the system comprising:
a database, wherein the database includes a plurality of scriptlets;
a knowledge base module that receives individualized subscriber attribute information and stores the subscriber attribute information in the database, the knowledge base including:
a data-query function configured to compare the individualized subscriber attribute information to the plurality of scriptlets to identify scriptlets matching the subscriber attribute information; and
a rules function configured to create a list of media clips associated with the scriptlets; and
a streaming media mixing and production module for streaming media clips from the list to a device associated with a subscriber.

15. The system of claim 14, further comprising a trainer module that enables a trainer to define a workout philosophy, the workout philosophy including selected exercises and methods for the selected exercises, the methods including one or more of a frequency, a cadence, a rep, a set and a rest.

16. The system of claim 14, further comprising a subscriber module that enables a subscriber to access a view of the subscriber's workout, conduct maintenance of the subscriber's information, and view selected scriptlets included in a particular media clip for a particular workout.

17. The system of claim 14, wherein the subscriber attribute information includes one or more of:
subscriber feedback;
subscriber profile;
subscriber behavior;
subscriber interests;
workout results; and
real time activity.

18. A method for generating adaptable, customized media content that is streamed to a subscriber, the method comprising:
storing pre-defined content in a knowledge base, the pre-defined content maintained by first subject matter experts;
storing second content from at least one subject matter expert, wherein the second content includes methods defined by the at least one subject matter expert;
storing a plurality of media clips, each media clip having attributes including at least a step and a description;
identifying specific media clips for a subscriber from the plurality of media clips based on a comparison between second information received from the subscriber, the pre-defined content and the second content;
producing media content for the subscriber by streaming at least a portion of the specific media clips to a device associated with the subscriber.

19. The method of claim 18, further comprising receiving additional information from the subscriber while the subscriber is experiencing the streaming media content.

20. The method of claim 19, further comprising, in response to receiving the additional information from the subscriber:
identifying new media clips for the subscriber from the plurality of media clips based on a comparison between information received from the subscriber, additional information received from the subscriber, the pre-defined content and the second content; and
producing modified media content for the subscriber by streaming at least a portion of the new media clips to the device associated with the subscriber.

21. The method of claim 19, wherein the additional information includes one or more of subscriber feedback, workout results and real time activity.

22. The method of claim 19, wherein the additional information is received from one or more devices associated with the subscriber, the one or more devices including one or more of a heart rate monitor, a treadmill and exercise equipment.

23. The method of claim 18, wherein storing second content from at least one subject matter expert comprises receiving the methods from the at least one subject matter expert, wherein each method identifies an exercise and associated attributes, the attributes including one or more of a frequency, a cadence, a number of repetitions, a number of sets, or a rest time.

24. The method of claim 18, further comprising receiving an update to the second content received from the subject matter expert, wherein the specific media clips are updated based on the update.

25. The method of claim 18, further comprising incorporating a subscriber selected song or video into the media content.

26. The method of claim 18, wherein the media content comprises at least one of media content for an exercise workout, media content for a study session, media content for a trip and media content for a session.

27. The method of claim 18, wherein the subject matter expert comprises an exercise trainer.

28. The method of claim 18, wherein the at least one subject matter expert accesses the knowledge base via a website interface.
